(19) United States
(12) Patent Application Publication
(10) Pub. No.: US 2017/0168677 A1
(43) Pub. Date: Jun. 15, 2017

(54) METHOD FOR REDUCING ALERT FATIGUE IN PROCESS CONTROL APPLICATIONS

(71) Applicant: BAKER HUGHES INCORPORATED, Houston, TX (US)

(72) Inventor: Coenraad SMITS, Houston, TX (US)

(73) Assignee: BAKER HUGHES INCORPORATED, Houston, TX (US)

(21) Appl. No.: 14/968,284

(22) Filed: Dec. 14, 2015

(51) Int. Cl. G06F 3/0481; G06F 3/0482; G08B 21/18; G06T 13/80

(52) U.S. Cl. CPC G06F 3/04817; G06T 13/80; G06F 3/0482; G08B 21/18; G06F 2203/04803

(57) ABSTRACT

A process can be controlled in such a way that alert fatigue can be mitigated or even avoided. The method includes employing icons representing notifications. The icons are employed in such a way that they travel from one part of a display screen to another, sometimes with the rate of movement corresponding to the period of relevancy of the notification. The icons can also be automated to facilitate viewing individual icons when he the screen is crowded with icons.

### BACKGROUND

1. Field of the Disclosure

The invention relates to displaying electronic process control information. The invention particularly relates to the displaying electronic process control notifications.

2. Background of the Disclosure

Mechanical, electrical, and chemical systems can be subject to failure if not properly controlled. For example, heat buildup in a mechanical engine such as one used to propel an automobile can be disastrous, even to the point of causing the entire engine to fail. In modern chemical plant processes, failure to control the same processes can be dangerous not just to the employees running the process but even to the public living in the vicinity of such processes.

Sensors have been employed in such processes to allow for a smooth and safe operation. For example, thermometers can be deployed within an automobile engine block to monitor engine temperature and pressure sensors can be deployed within a chemical process to ensure that no overpressure your occurs.

Since the early 20^{th} century, operators of such processes have deployed technology to augment the use of such sensors. Exemplary of such technology would be set point alarms, ruptured disc monitors, and the like wherein unsafe are critical situations can be brought to the attention of an operator by means of an alarm.

Since the latter part of the 20^{th} century, the development of computers has allowed the use of such alarms to become more sophisticated. Now, instead of just simply having alarm situations indicating danger or imminent process failure, messages to operators need to be categorized. For example, in addition to a true “alarm,” modern process control systems typically issue informational notifications. Such notifications include but are not limited to warnings, errors, status updates, and the like.

One problem encountered during operation of such processes is the so-called “alert fatigue.” Prior to the common use of computer displays it was not unusual for a control room to be subject to a cacophony of different alarms. With the advent of computer displays the same cacophony occurs but it is in the form of messages electronically displayed. When the operator is subjected to too many such messages in too short of a time span, the operator may be subject to alert fatigue and important messages can be overlooked. It would be desirable in the art of controlling processes to be able to eliminate or at least mitigate alert fatigue.

### SUMMARY

In one aspect, the invention is a method for controlling a process comprising employing a notification visualization discipline wherein: a plurality of icons is displayed on a display screen wherein each icon is a single message, the plurality of icons is displayed within a defined region of the display screen, the defined region of the display screen is delimited by a border, the icons move from a first edge of the border of the defined region to an opposite edge of the border the defined region, and an individual icon moves with a velocity such that it traverses the space between the first edge and the opposite edge of the border of the defined region over a period of time substantially the same as the period of time for which the message associated with the individual icon is relevant to the process being controlled.

In another aspect, the invention is a method for controlling a process comprising employing a notification visualization discipline wherein: a plurality of icons is displayed on a display screen wherein each icon is a single message, the plurality of icons is displayed within a defined region of the display screen, the defined region of the display screen is delimited by a border, the icons move from a first edge of the border of the defined region to an opposite edge of the border the defined region, and upon reaching the opposite edge of the border of the defined region, the subject icon either passes off the screen or accumulates at the top of the screen by default.

In still another aspect, the invention is a system for controlling a process comprising a sensor, a controller, a computer processor, and a display screen wherein the system is configured to employ a method for controlling a process comprising employing a notification visualization discipline wherein: a plurality of icons is displayed on a display screen wherein each icon is a single message, the plurality of icons is displayed within a defined region of the display screen, the defined region of the display screen is delimited by a border, and the icons move from a first edge of the border of the defined region to an opposite edge of the border the defined region.

### BRIEF DESCRIPTION OF THE DRAWINGS

The other objects, features and advantages will occur to those skilled in the art from the following description of the preferred embodiment and the accompanying drawings in which:

FIG. 1 is an illustration of a display screen showing an embodiment of the method of the application; and

FIG. 2 is an exemplary illustration of a conventional display of warning and alarms.

### DESCRIPTION

In one embodiment, the invention is a method for controlling a process comprising employing a notification visualization discipline wherein: a plurality of icons is displayed on a display screen wherein each icon is a single message, the plurality of icons is displayed within a defined region of the display screen, the defined region of the display screen is delimited by a border, the icons move from a first edge of the border of the defined region to an opposite edge of the border the defined region, and an individual icon moves with a velocity such that it traverses the space between the first edge and the opposite edge of the border of the defined region over a period of time substantially the same as the period of time for which the message associated with the individual icon is relevant to the process being controlled.

For the purpose of this application, the term “controlling a process” means employing the method of the application to control certain oilfield operations, refining of hydrocarbons, production of chemicals, and power plant operations. The oilfield operations for which the method of the application is useful include, but are not limited to: logging; hydrocarbon production; well stimulation; and reservoir simulation.

For the purposes of this application, the term “notification visualization discipline” means a procedure of displaying information employing icons moving on a display screen subject to rules set forth elsewhere in this application.

In practicing the method of this application, icons are employed to represent messages relating to a process being controlled. In one embodiment of the application the icons are graphic representations of bubbles. Bubbles are especially appropriate when the defined region of the display screen is oriented such that the icons move from the bottom of the screen to the top of the screen similar to the motion of a bubble rising in water. While a “bubble” icon is a desirable embodiment, other icons can be used. Any icon can be used, but in most embodiments the icons will be subject to being scalable to be recognizable within the defined region of the display screen. Also, the icons do not necessarily have to move from bottom of the screen to top of the screen. For example, the icons could move along a defined region of a display screen wherein that defined region lay along the top 2 inches of the display screen and the motion of the icons is sideways. Similarly, icons can also move from the top of the screen towards the bottom of the screen.

The defined region of the display screen is delimited by a border. While in some embodiments the border may not be visible in many embodiments it will be visible. Where the border of the defined region of the display screen is visible it could be selected from lines, bars, graphical representations of real-world objects such as a picture frame, and the like.

In practicing the method of the application, icons representing messages are displayed on a display screen. One such message is an alarm. For the purposes the present application an alarm messages is one indicating that some aspect of the process requires immediate attention. Exemplary of such alarms would be over pressure situations, loss of system integrity, exceeding heat setpoints, and the like.

Other messages which would be desirably displayed within the method of the application include but are not limited to warnings, error messages, status updates, and the like. These terms all have their normal meaning within the English language; but typically would not be urgent nor indicative of a catastrophic failure.

In some embodiments of the method of the application, there will be a display screen having two or more defined regions where each of the defined regions shows icons relating to a single process or even a portion of a single process. In the alternative, all of the messages for a process could be displayed within a single defined region of a display screen employing the method of the application.

In practicing the method of the application, in some embodiments some of the icons may move at a faster velocity through the defined region of the display screen than others. In such embodiments, the icons would move with a velocity sufficient to keep them moving on the display screen for a time period consistent with the period of time for which the subject message would be relevant. For example, if an icon were associated with a message declaring that a certain pump or valve used within a process was going to be locked out for 2 hours, then that warning icon would move at a velocity such that it would move from one side of the defined area to the other in about 2 hours.

In one embodiment of the method of the application, the icons do not move in a strictly linear direction. Screen animation of the icons could be employed to impart additional information. For example, the icons could “swirl.” Allowing the icons to swirl offers several advantages. Where there are a lot of icons present on the display screen at any given time, having the icons swirl would allow the operator to readily see all the notices at any given point along the defined region of the display screen. In a slightly different embodiment, the speed at which an icon swirls could be indicative of the type of message associated with it. For example, alarms could swirl faster than error messages. Any form of animation of the icons known to those of ordinary skill in the art can be employed with the method of the application.

Once an icon reaches the opposite edge of the defined region of the display screen there are several possibilities regarding what can happen with it. One option is that the icon reaches the top of the screen and stays there until it is dismissed by an operator. Another option would be that the icon reaches the top of the screen and scrolls off the screen. Still another option would be that the icons would reach the top of the screen and some of the icons would scroll off the screen and others would stay on the screen based upon what type of icon they were. For example, it may be desirable to have a default in the visualization discipline where alarms and warnings accumulated at the top of the screen until dismissed while notifications scroll off the screen.

No matter what the default regarding the fate of the icons as they reach the top of the screen, some embodiments of the method of the application would allow for the operator to select what occurs with the icon. For example, the operator may elect to keep only alarms and dismiss all other notifications.

While it is desirable that in some embodiments of the method of the application that the icons have variable velocities, in other embodiments the icons all move at the same rate of speed. In such embodiments, it would be desirable that the operator be able to dismiss an icon even prior to it reaching the opposite side of the defined area. One advantage of this particular embodiment would be that notifications issuing in a specific time span, say 2 hours, would be moving and therefore be clearly “fresh” while older and possibly stale icons would be either scrolled off the screen or sitting at the top of the screen.

In one desirable embodiment of the method of the application, an operator viewing the icons can select the icons in order to read the notification associated there with. In systems using touch screens an operator can even touch an icon and then by pinching or stretching the screen ascertain additional information including but not limited to when the notification was declared by the system and how much longer it would be relevant. Of course, the analogous process can be done on non-touch screen systems as well.

To the extent that there is any animation occurring with the icons, it would be desirable in some embodiments of the method of the application that such animations (like swirling) slow down or stop while being observed by the operator.

In one embodiment of the method of the application, an operator may choose to change the aspect for a section of the defined screen. When zooming in or out, the operator can change the period of time for which he is viewing notifications. If he zooms in, he will see a smaller segment of time; if he zooms out, he can see both older and newer notifications around the point at which he is centered, but fewer of each,

Systems useful for practicing the method of the application include those that have a sensor, a controller, a computer processor, and a display screen. In such systems, the sensor is employed in a process to monitor at least one parameter of that process. Also present in that process is a controller which can be employed to regulate or otherwise affect some aspect of that process. For example the controller could be one that opens or closes a valve or regulates the speed of a motor, or the like. Both the sensor and the controller would be connected either directly or indirectly to the computer processor. The computer processor would also be configured to output notifications to the display screen using the discipline of the method of the application.

When employed, the system of the application would be useful for sensing a condition in a process, and when necessary outputting a warning or alarm to the display screen. An operator, reacting to the warning or alarm, could then employ the controller to resolve the problem causing the alarm or warning condition.

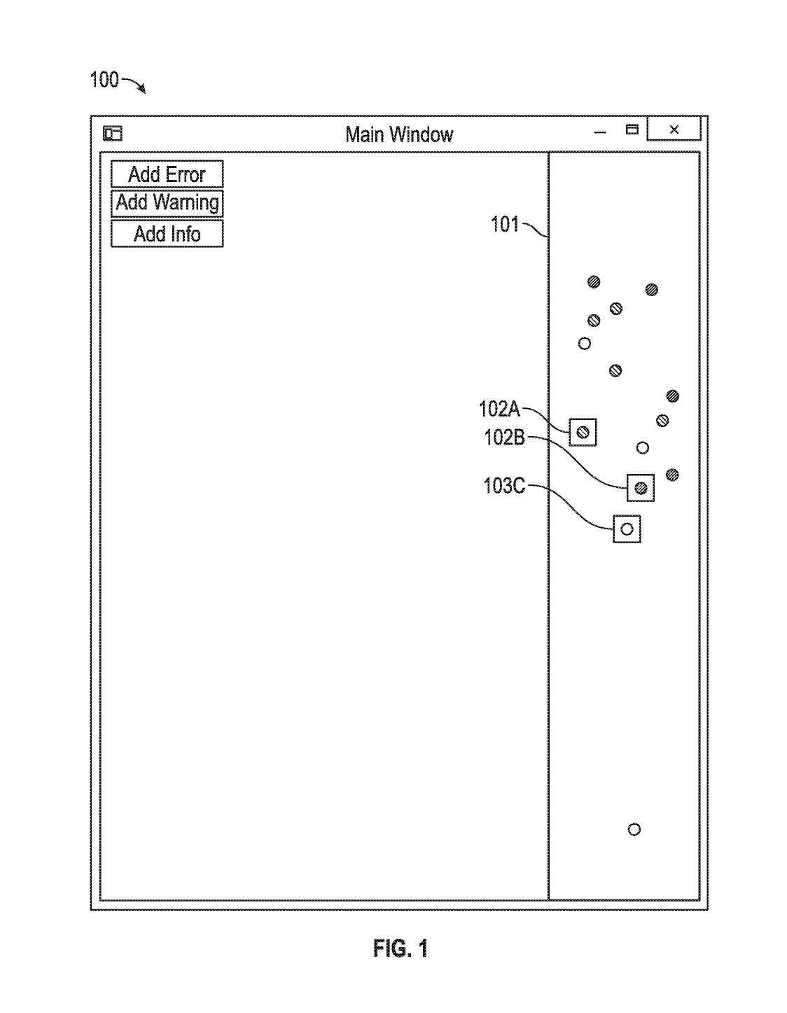

Turning now to FIG. 1, reference number (100) illustrates a display screen showing defined region of the display screen (101). Within that region, there are 3 icons illustrated (102). The 1^{st} icon (102A) is a warning icon. The 2^{nd} icon (102B) is an alarm icon. Finally, the 3^{rd} icon (102C) is an error message icon. In this particular embodiment the icons are moving from the bottom of the screen towards the top of the screen. Also, in this particular embodiment, there are no icons accumulating at the top of the screen.

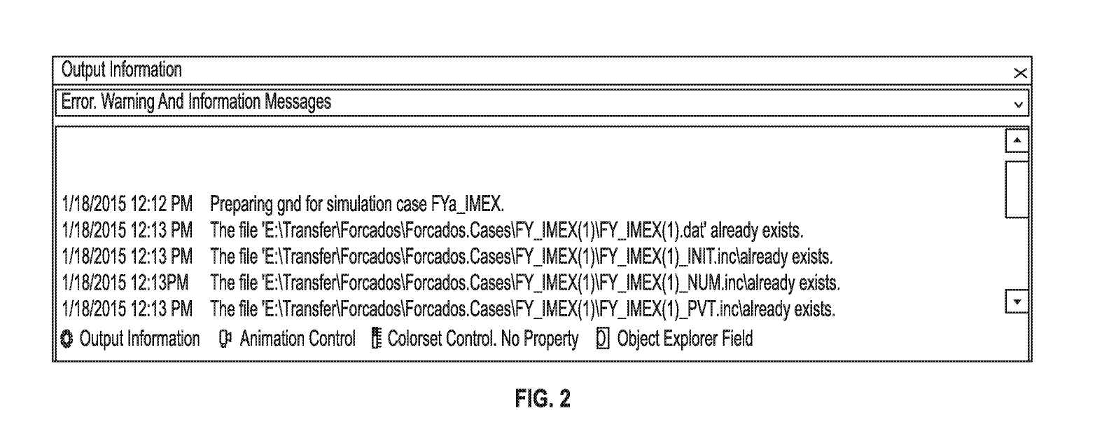

Turning now to FIG. 2, a conventional era, warning, and information message display is shown. Note that 4 of the messages were output at 1213. The other 2 were output at 1212. This illustrates problems common in controlling complicated processes. One problem is the fact that so many messages came so quickly. When too many messages occur over too short a time period the operator may becomes overwhelmed. When this occurs, the relativity of time is lost. Another effect of this is that earlier messages tend to be overlooked. Also, as illustrated the messages are not sorted per process or type of message which can introduce confusion along with all of the other issues. These are symptoms consistent with alert fatigue.

In marked contrast, the method of the present application avoids all of those issues. By avoiding these issues, alert fatigue is if not fully avoided at least substantially mitigated.

The method of the application can be employed with enhancements already employed in the art. For example, the icons can be of different colors. An alarm could be colored red which would be consistent with most practices. The other types of notifications could have a different color assigned to them as well.

1. A method for controlling a process comprising employing a notification visualization discipline wherein:
a plurality of icons is displayed on a display screen wherein each icon is a single message,
the plurality of icons is displayed within a defined region of the display screen,
the defined region of the display screen is delimited by a border,
the icons move from a first edge of the border of the defined region to an opposite edge of the border the defined region, and
an individual icon moves with a velocity such that it traverses the space between the first edge and the opposite edge of the border of the defined region over a period of time substantially the same as the period of time for which the message associated with the individual icon is relevant to the process being controlled.

2. The method of claim 1 wherein the process being controlled is selected from the group consisting of: oilfield operations, refining hydrocarbons, producing chemicals, and power plant operations.

3. The method of claim 2 wherein the process being controlled is an oilfield operations selected from the group consisting of logging, hydrocarbon production, oil well stimulation, and reservoir stimulation.

4. The method of claim 1 wherein the icon is an illustration of a bubble.

5. The method of claim 1 wherein the icons are animated.

6. The method of claim 5 wherein the animation is “swirling.”

7. The method of claim 1 wherein the defined region of the display screen is on the side of the display screen.

8. The method of claim 7 wherein the icons move from the bottom of the screen to the top of the screen.

9. The method of claim 1 wherein the defined region of the screen is delimited by a bar.

10. The method of claim 1 wherein the icons are color coded to distinguish between types of notifications.

11. A method for controlling a process comprising employing a notification visualization discipline wherein:
a plurality of icons is displayed on a display screen wherein each icon is a single message,
the plurality of icons is displayed within a defined region of the display screen,
the defined region of the display screen is delimited by a border,
the icons move from a first edge of the border of the defined region to an opposite edge of the border the defined region, and
upon reaching the opposite edge of the border of the defined region, the subject icon either passes off the screen or accumulates at the top of the screen by default.

12. The method of claim 11 wherein the process being controlled is selected from the group consisting of: oilfield operations, refining hydrocarbons, producing chemicals, and power plant operations.

13. The method of claim 12 wherein the process being controlled is an oilfield operations selected from the group consisting of logging, hydrocarbon production, oil well stimulation, and reservoir stimulation.

14. The method of claim 11 wherein the icon is an illustration of a bubble.

15. The method of claim 11 wherein the icons are animated.

16. The method of claim 15 wherein the animation is “swirling.”

17. The method of claim 11 wherein the defined region of the display screen is on the side of the display screen.

18. The method of claim 17 wherein the icons move from the bottom of the screen to the top of the screen.

19. The method of claim 11 wherein the defined region of the screen is delimited by a bar.

20. A system for controlling a process comprising a sensor, a controller, a computer processor, and a display screen wherein the system is configured to employ a method for controlling a process comprising employing a notification visualization discipline wherein:
a plurality of icons is displayed on a display screen wherein each icon is a single message,
the plurality of icons is displayed within a defined region of the display screen,
the defined region of the display screen is delimited by a border, and
the icons move from a first edge of the border of the defined region to an opposite edge of the border the defined region.
